(19) United States
(12) Patent Application Publication
(10) Pub. No.: US 2015/0049465 A1
(43) Pub. Date: Feb. 19, 2015

(54) BACKLIGHT UNIT, DISPLAY DEVICE INCLUDING THE SAME, AND METHOD OF MANUFACTURING THE SAME

(71) Applicant: Samsung Display Co., Ltd., Yongin-city (KR)

(72) Inventors: Se Ki PARK, Hwaseong-si (KR); Byoung Dae Ye, Yongin-si (KR); Seok Hyun Nam, Seoul (KR)

(21) Appl. No.: 14/335,053

(22) Filed: Jul. 18, 2014

(30) Foreign Application Priority Data
Aug. 19, 2013 (KR) 10-2013-0098014

(51) Int. Cl. H05B 33/12; G02F 1/1335; H05B 33/08

(52) U.S. Cl. CPC H05B 33/12; H05B 33/08; G02F 1/133602; G02F 1/133606; G02F 2001/133612; G02F 2001/133607
USPC 362/97.1

(57) ABSTRACT

Disclosed are a backlight unit and a display device including the same. The backlight unit includes: an upper substrate; and a plurality of light source units disposed under the upper substrate, in which the light source unit includes an upper electrode, a lower electrode, and an inorganic emission layer disposed between the upper electrode and the lower electrode, and in the adjacent light source units among the plurality of light source units, at least one of the upper electrodes and the lower electrodes are electrically separated from each other.

### CROSS-REFERENCE TO RELATED APPLICATION

This application claims priority from and the benefit of Korean Patent Application No. 10-2013-0098014, filed on Aug. 19, 2013, which is hereby incorporated by reference for all purposes as if fully set forth herein.

### BACKGROUND

1. Field

Exemplary embodiments of the present invention relate to a backlight unit and a display device including the same.

2. Discussion of the Background

Among the flat panel displays, the liquid crystal display (LCD), has particular advantages, such as small screen size, weight reduction, and low power consumption. The LCD, therefore, has gradually become accepted as a device capable of overcoming drawbacks of the existing cathode ray tube (CRT). Because of these qualities, the LCD has been integrated in many information processing devices that require a display device.

In general, the liquid crystal display is a device that generates an electric field by applying different potentials to a pixel electrode and a common electrode. A liquid crystal material is injected between an upper substrate, on which the common electrode, a color filter, and the like are formed, and a lower substrate, on which a thin film transistor, the pixel electrode, and the like, are formed. These elements change an arrangement of liquid crystal molecules and control transmittance of light, thereby displaying images.

In the liquid crystal display, a liquid crystal panel is a non-emissive element. As such, it does not emit light for itself and typically includes a backlight unit for providing light to the panel from the panel's underside.

The backlight unit, such as a cold cathode fluorescent lamp (CCFL), may use a phosphor and a photodiode as a light source. These types of backlights are further classified as edge-type backlight units and/or direct type backlight units, depending on a position of the light source.

The above information disclosed in this Background section is only for enhancement of understanding of the background of the invention and therefore it may contain information that does not form the prior art that is already known in this country to a person of ordinary skill in the art.

### SUMMARY

Exemplary embodiments of the present invention provide a backlight unit capable of switching a portion of a plurality of light sources including an inorganic emission layer, on and off, and a display device including the same.

Additional features of the invention will be set forth in the description which follows, and in part will be apparent from the description, or may be learned by practice of the invention.

An exemplary embodiment of the present invention discloses a backlight unit including an upper substrate and a plurality of light source units disposed under the upper substrate, in which the light source unit includes an upper electrode, a lower electrode, and an inorganic emission layer disposed between the upper electrode and the lower electrode, and in the adjacent light source units among the plurality of light source units, at least one of the upper electrodes and the lower electrodes being electrically separated from each other.

An exemplary embodiment of the present invention also discloses a display device, including: a non-emissive display panel; and a backlight unit providing light to the non-emissive display panel, in which the backlight unit includes: an upper substrate; and a plurality of light source units which are disposed under the upper substrate, and the light source unit includes an upper electrode, a lower electrode, and an inorganic emission layer disposed between the upper electrode and the lower electrode, and in the adjacent light source units among the plurality of light source units, at least one of the upper electrodes and the lower electrodes are electrically separated from each other.

As set forth above, it is possible to switch on and off only specific regions of the backlight unit by controlling the inorganic emission layer to emit light or not to emit light by different signals. This is achieved by separating at least one of the pair of electrodes which is disposed on the upper and lower portions of the adjacent inorganic emission layers. Further, it is possible to determine the size of the light source that is switched on and off by changing the size of the electrode. Thus, it is possible to dim a very small portion of the screen by turning off the light source only for the region and by making the size of the electrode very small. As a result, the display device using the backlight unit can finely control the display, thereby improving the display quality. Further, a portion with no need for backlighting can be turned off, thereby decreasing the power consumption.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a display device according to an exemplary embodiment of the present invention.

FIG. 2 is a layout view of a backlight unit according to an exemplary embodiment of the present invention.

FIG. 3 is a perspective view illustrating two light source units of a backlight unit according to the exemplary embodiment of the present invention.

FIG. 4 is a layout view of a backlight unit according to another exemplary embodiment of the present invention.

FIG. 5 is a perspective view illustrating one light source unit of the backlight unit according to another exemplary embodiment of the present invention.

FIG. 6 is a layout view of the backlight unit according to another exemplary embodiment of the present invention.

FIG. 7 is a perspective view illustrating two light source units of the backlight unit according to another exemplary embodiment of the present invention.

FIG. 8 is a perspective view illustrating one light source unit of a backlight unit according to another exemplary embodiment of the present invention.

FIG. 9 is a circuit diagram of the backlight unit according to another exemplary embodiment of the present invention.

FIG. 10 is a layout view of a portion of the backlight unit according to another exemplary embodiment of the present invention.

FIG. 11 is a circuit diagram illustrating the backlight unit according to another exemplary embodiment of the present invention.

FIGS. 12 and 13 are perspective views illustrating a configuration of the light source unit depending on a display color according to the exemplary embodiment of the present invention.

FIG. 14 is a cross-sectional view of a light source unit according to another exemplary embodiment of the present invention.

FIG. 15 is a table illustrating characteristics of the backlight unit according to the exemplary embodiment of the present invention.

### DETAILED DESCRIPTION OF THE ILLUSTRATED EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

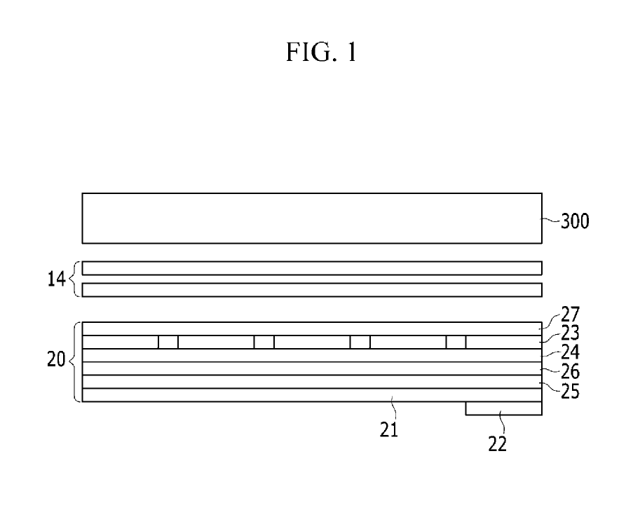

Hereinafter, a backlight unit and a display device including the same according to an exemplary embodiment of the present invention will be described in detail with reference to FIG. 1.

FIG. 1 is a cross-sectional view of a display device according to the exemplary embodiment of the present invention.

FIG. 1 illustrates a non-emissive display device using a backlight unit. A representative non-emissive display device is a liquid crystal display.

In FIG. 1, the non-emissive display device includes a non-emissive display panel 300, a backlight unit 20 disposed thereunder, and an optical sheet 14 which improves characteristics of light provided from the backlight unit 20 and is disposed between the backlight unit 20 and the non-emissive display panel 300.

Non-emissive display panel 300 may be any non-emissive display panel, for example, a liquid crystal panel. However, the disclosure is not limited thereto, as other non-emissive display panels, such as a panel using a micro shutter, an electrophoretic display panel, an electrowetting display panel, and many others, may be used.

Light is provided from under the non-emissive display panel 300, and the non-emissive display panel 300 transmits and blocks the corresponding light to display a gray scale. The liquid crystal panel may be outfitted with upper and lower polarizers. Light polarized by the lower polarizer has its polarization characteristics changed when passing through a liquid crystal layer and is then transmitted or is not transmitted in the upper polarizer to display a gray scale.

The backlight unit 20 is disposed under the non-emissive display panel 300 and the optical sheet 14 is disposed between the non-emissive display panel 300 and the backlight unit 20 to improve characteristics of light provided from the backlight unit 20.

Although FIG. 1 illustrates only two sheets, the optical sheet 14 may include a plurality of sheets, which may be of various compositions and provided for various purposes. For example, the sheet included in the optical sheet 14 may include a prism sheet having prisms a surface thereof, a diffuser sheet diffusing light, and a luminance enhancement film such as dual brightness enhancement film (DBEF) in which two layers having different refractive indexes are alternately formed. The optical sheet 14 may be included in the backlight unit 20.

The backlight unit 20 according to the exemplary embodiment of the present invention includes an inorganic emission layer 26, insulating layers 24 and 25 disposed at both sides of the inorganic emission layer 26, a pair of electrodes 21 and 23 disposed outside each of the insulating layers 24 and 25, a wiring 22-1 that applies a signal to a lower electrode 21, and an upper substrate 27 which covers the inorganic emission layer 26 and the electrodes 21 and 23. The optical sheet 14 is disposed on the upper substrate 27.

The backlight unit 20 includes a plurality of light source units, in which one of the light source units includes the pair of electrodes 21 and 23 and the inorganic emission layer 26 disposed therebetween. The insulating layers 24 and 25 are disposed between the inorganic emission layer 26 and the pair of electrodes 21 and 23 to serve to protect the inorganic emission layer 26 from direct contact with the electrodes 21 and 23. Alternatively, the insulating layers 24 and 25 may be disposed on only one side of the inorganic emission layer 26 and may not be disposed at both sides thereof. One of the pair of electrodes 21 and 23 may be comprised of a transparent conductive material and the other one may be comprised of metal. Light of the inorganic emission layer 26 is emitted to a side made of the transparent conductive material. In the exemplary embodiment of the present invention, since light needs to be emitted towards the display, the lower electrode 21 may be comprised of a metal, for example, magnesium (Mg), aluminum (Al), and sliver, and the upper electrode 23 may be made of a transparent conductive material, such as indium tin oxide (ITO) and indium zinc oxide (IZO). The backlight unit 20 may have a direct type structure in which the one light source unit is arranged in a matrix and the light source is under the backlight unit 20.

At least one of the electrodes 21 and 23 includes portions that are separated from each other so that the light source units of the backlight unit 20 according to the exemplary embodiment of the present invention may be switched on and off by being separated from each other. FIG. 1 illustrates an exemplary embodiment having a structure in which the upper electrodes 23 are separated from each other. At least one of the light source units included in the backlight unit 20 share the inorganic emission layer 26. That is, in the adjacent light source units, at least one of the pair of electrodes 21 and 23 are separated from each other and connected to each other through the inorganic emission layer 26. According to the exemplary embodiment of the present invention, all the light source units included in the backlight unit 20 may share the inorganic emission layers 26 since the inorganic emission layers 26 are connected to each other.

Light source units may be of various sizes and the entire display area may be divided into various numbers of regions. In the case of about 40 inch display area, a grid of 6×8 light source units may be formed and the light source units may also be formed in number larger than the above number. The light source unit of FIG. 1 corresponds to a region in which the pair of electrodes 21 and 23 overlap each other, and therefore the size of the light source unit may be formed to be very small. However, when the size of the light source unit is too small, there is a problem in that the change in display quality due to a switch on or off is small and unpronounced. Therefore, various number of light source units may be provided, according to the exemplary embodiment of the present invention.

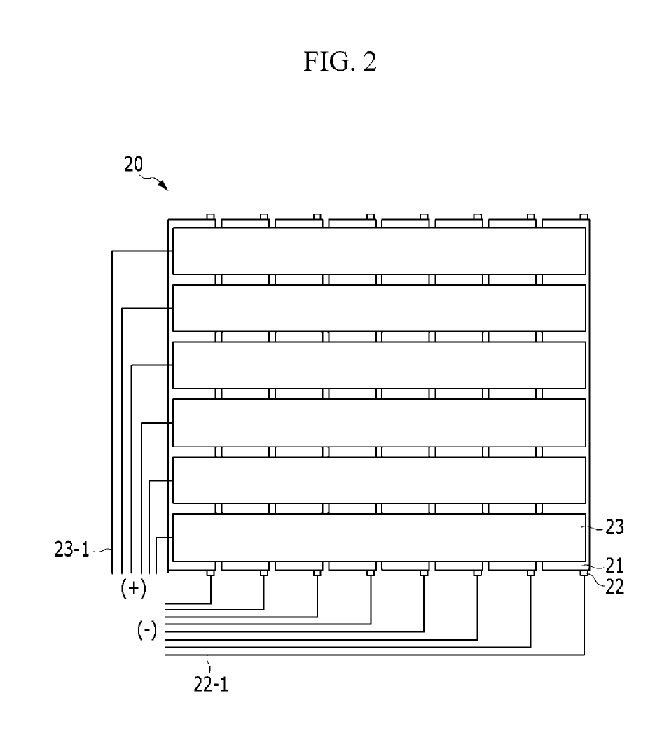

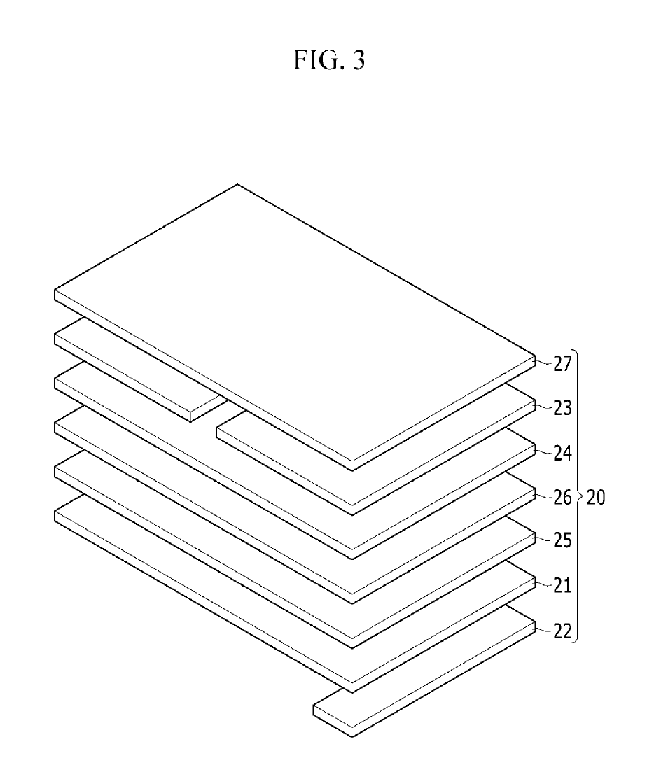

Hereinafter, the backlight unit according to the exemplary embodiment of the present invention will be described with reference to FIGS. 2 and 3.

FIG. 2 is a layout view of a backlight unit according to an exemplary embodiment of the present invention. FIG. 3 is a perspective view illustrating two light source units of a backlight unit according to the exemplary embodiment of the present invention.

The exemplary embodiment of FIGS. 2 and 3 has a structure in which the upper electrodes 23 extend in a horizontal direction and the lower electrodes 21 extend in a vertical direction. According to the above structure, light is emitted from the inorganic emission layer 26 of the light source unit when a positive voltage applied to the upper electrode 23 and a negative voltage applied to the lower electrode 21 are applied together. A method of selecting the light source unit by the above method may be referred to as a passive method.

The structure of the backlight unit 20 according to the exemplary embodiment of the present invention will be described in detail with reference to FIGS. 2 and 3.

The upper electrode 23 is disposed beneath the upper substrate 27, which may be made of various materials, such as glass or a flexible plastic, such as polyethylene terephthalate (PET). The upper electrode 23 may be made of a transparent conductive material such as ITO and IZO and may be provided with a plurality of linear electrodes formed in parallel, which extends in a first direction (horizontal direction in the exemplary embodiment). The upper electrode 23 may be configured to be an anode, in which light is emitted through the upper electrode 23. The upper electrodes 23 are each connected to first wirings 23-1 which apply a voltage to the upper electrodes 23. The upper electrodes 23 are each connected to the first wirings 23-1, such that each of the upper electrodes 23 may be applied with different voltages.

The inorganic emission layer 26 is disposed under the upper electrode 23 and the upper insulating layer 24 is disposed between the inorganic emission layer 26 and the upper electrode 23. The upper insulating layer 24 may be made of an inorganic insulating material or an organic insulating material and may be configured to protect the inorganic emission layer 26. The upper insulating layer 24 may be omitted according to the exemplary embodiment.

The inorganic emission layer 26 is disposed beneath the upper insulating layer 24.

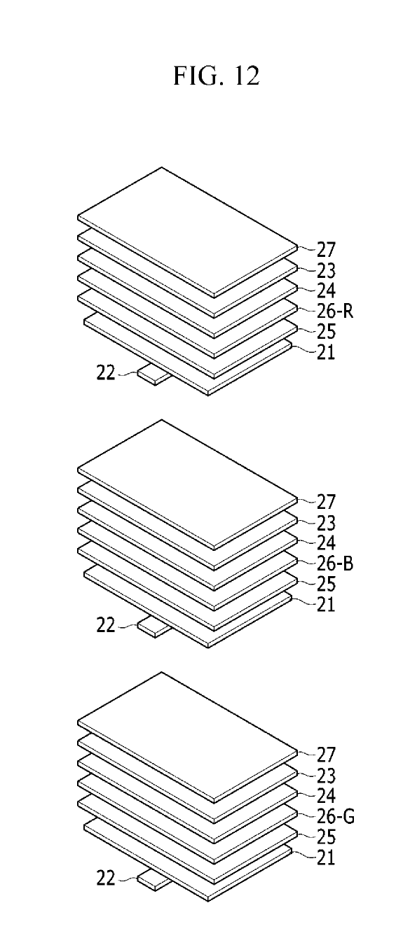

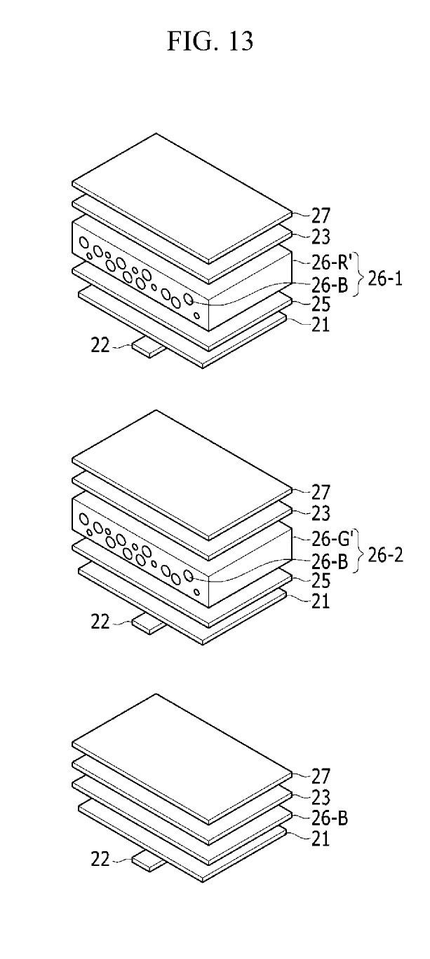

The inorganic emission layer 26 is made of an inorganic material and may have fluorescent characteristics wherein light is emitted by an applied current. The inorganic material used in the inorganic emission layer 26 may vary and, thus, a wavelength of light emitted inorganic materials may be different corresponding to the inorganic material used. For example, the inorganic emission layer 26 may emit light having a blue wavelength and may also change the wavelength of light which is emitted using an additional fluorescent material. Further, various combinations may be implemented, depending on the developed inorganic fluorescent material. The inorganic emission layer 26 may be formed of BaAl2S4:Eu (blue), CaAl2S4:Eu (green), or SrCaY2S4:Eu (red), but is not limited thereto. This will be described with reference to FIGS. 12 and 13.

The lower insulating layer 25 is disposed beneath the inorganic emission layer 26. The lower insulating layer 25 may be made of an inorganic insulating material or an organic insulating material and may serve to protect the inorganic emission layer 26. The lower insulating layer 25 may be omitted according to an exemplary embodiment of the present invention. At least one of the lower insulating layer 25 and the upper insulating layer 24 may be included and the materials configuring the upper insulating layer 24 and the lower insulating layer 25 may be the same. Unlike organic light emitting material, even though inorganic light emitting material configuring the inorganic emission layer 26 is exposed to moisture, the inorganic light emitting material is not detrimentally degraded even when the inorganic light emitting material is not completely blocked from the outside. As a result, the inorganic light emitting material does not require an additional manufacturing process and structure to be blocked from the outside.

The lower electrode 21 is disposed beneath the lower insulating layer 25. The lower electrode 21 may be made of an opaque metal, such as magnesium (Mg), aluminum (Al), and silver (Ag) and is provided with a plurality of linear electrodes formed in parallel, which extend in a second direction (vertical direction in the exemplary embodiment of the present invention). The lower electrode 21 may be configured as a cathode and reflects light, such that light is not emitted beyond the electrode 21.

An auxiliary electrode 22 is formed beneath the lower electrode 21 under the area occupied by the lower electrode 21. The auxiliary electrode 22 extends along an direction of the lower electrode 21 and is formed to overlap the lower electrode 21. The auxiliary electrode 22 may contact the lower electrode 21 to directly transfer a signal applied to the auxiliary electrode 22 to the lower electrode 21. The auxiliary electrode 22 may be made of metal such as copper (Cu) to improve signal transfer characteristics of the lower electrode 21.

The auxiliary electrodes 22 are each connected to second wirings 22-1 that apply a voltage to the lower electrode 21. The auxiliary electrodes 22 are each connected to the second wirings 22-1, such that each of the auxiliary electrodes 22 may be applied with different voltages.

FIG. 3 is a perspective view illustrating two light source units which are adjacently disposed to each other in a vertical direction.

As illustrated in FIG. 3, the two light source units which are disposed adjacent to each other in a vertical direction have the upper electrodes 23 which are separated from each other, such that the two light source units may be switched on and off at different timings.

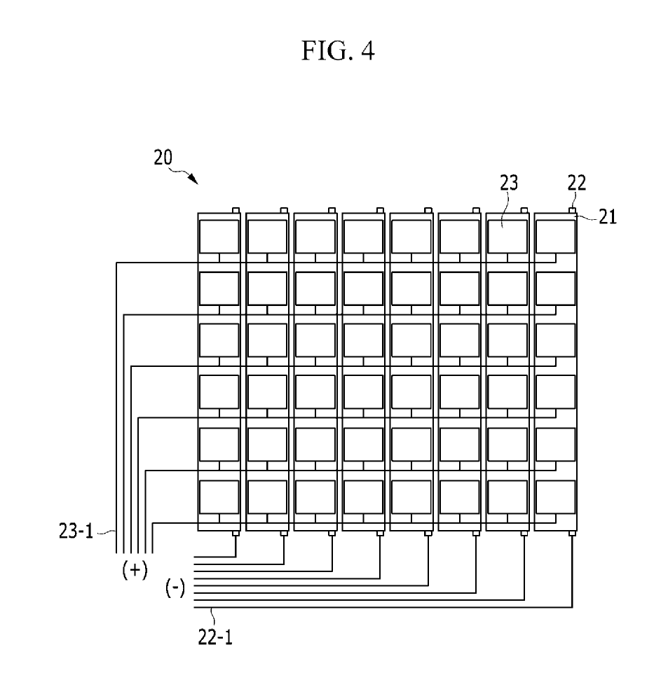

Hereinafter, a backlight unit according to another exemplary embodiment of the present invention will be described with reference to FIG. 4.

FIG. 4 is a layout view of a backlight unit according to another exemplary embodiment of the present invention.

Unlike the exemplary embodiment of FIGS. 2 and 3, in the exemplary embodiment of FIG. 4, the upper electrodes 23 are formed being separated for each light source unit. However, the first wirings 23-1 which connect the upper electrodes 23 apply the same voltage to the plurality of upper electrodes 23 which are disposed in the first direction (horizontal direction), such that the exemplary embodiment of the present invention is operated to be substantially the same as the exemplary embodiment of FIGS. 2 and 3. That is, light is emitted from the inorganic emission layer 26 of the selected light source unit when a positive voltage applied to the upper electrode 23 and a negative voltage applied to the lower electrode 21 are applied together. A method of selecting the light source unit by the above method may be referred to as a passive method.

The structure of the backlight unit 20 according to the exemplary embodiment of the present invention will be described in detail with reference to FIG. 4.

The upper electrode 23 is disposed beneath the upper substrate 27 which may be of various materials, such as glass or flexible plastic; for example, polyethylene terephthalate (PET). The upper electrode 23 may be made of a transparent conductive material such as ITO and IZO and is formed separately for each light source unit. Like the light source unit, the upper electrode 23 may be arranged in a matrix. Further, the upper electrode 23 is configured to be an anode, in which light is emitted through the upper electrode 23.

The upper electrodes 23 are each connected to first wirings 23-1 which apply a voltage to the upper electrodes 23 from the outside. In particular, the plurality of upper electrodes 23 which are arranged in the first direction (horizontal direction) among the upper electrodes 23 which are arranged in a matrix type are connected to each other by one wiring 23-1. As a result, the upper electrodes 23 may apply different voltages to each row.

The inorganic emission layer 26 is disposed under the upper electrode 23 and the upper insulating layer 24 is disposed between the inorganic emission layer 26 and the upper electrode 23. The upper insulating layer 24 may be made of an inorganic insulating material or an organic insulating material and may be configured to protect the inorganic emission layer 26. The upper insulating layer 24 may be omitted according to the exemplary embodiment of the present invention.

The inorganic emission layer 26 is disposed beneath the upper insulating layer 24.

The inorganic emission layer 26 is made of an inorganic material having fluorescent characteristics when light is emitted by an applied current. The inorganic material used in the inorganic emission layer 26 may include various materials and, thus, a wavelength of light emitted may be different depending on the inorganic material used. For example, an inorganic emission layer 26 emitting light having a blue wavelength may also change a wavelength of light emitted using an additional fluorescent material. Further, various combinations may be also be implemented, depending on the developed inorganic fluorescent material. This will be described with reference to FIGS. 12 and 13.

The lower insulating layer 25 is disposed beneath the inorganic emission layer 26. The lower insulating layer 25 may be made of an inorganic insulating material or an organic insulating material and may be configured to protect the inorganic emission layer 26. Insulating layer 25 may include an inorganic insulating film and an organic insulating film, and the inorganic insulating film may include a nitride layer and an oxied film, but is not limited thereto. The lower insulating layer 25 may be omitted. At least one of the lower insulating layer 25 and the upper insulating layer 24 may be included and the materials configuring the upper insulating layer 24 and the lower insulating layer 25 may also be the same.

The lower electrode 21 is disposed beneath the lower insulating layer 25. The lower electrode 21 may be made of an opaque metal, such as magnesium (Mg), aluminum (Al), and silver (Ag) and is provided with a plurality of linear electrodes formed in parallel, which extend in a second direction (vertical direction in the exemplary embodiment). The lower electrode 21 is configured to be a cathode and reflects light, such that light is not emitted beyond the lower electrode 21.

The auxiliary electrode 22 is formed beneath the lower electrode 21 under the area occupied by the lower electrode 21. The auxiliary electrode 22 extends along an extending direction of the lower electrode 21 and is formed to overlap the lower electrode 21. The auxiliary electrode 22 contacts the lower electrode 21 to transfer a signal applied to the auxiliary electrode 22 to the lower electrode 21. The auxiliary electrode 22 may be made of any metal that improves signal transfer characteristics of the lower electrode 21, such as copper (Cu).

The auxiliary electrodes 22 are each connected to the second wirings 22-1 which apply a voltage to the lower electrode 21. The auxiliary electrodes 22 are each connected to the second wirings 22-1, such that each of the auxiliary electrodes 22 may be applied with different voltages.

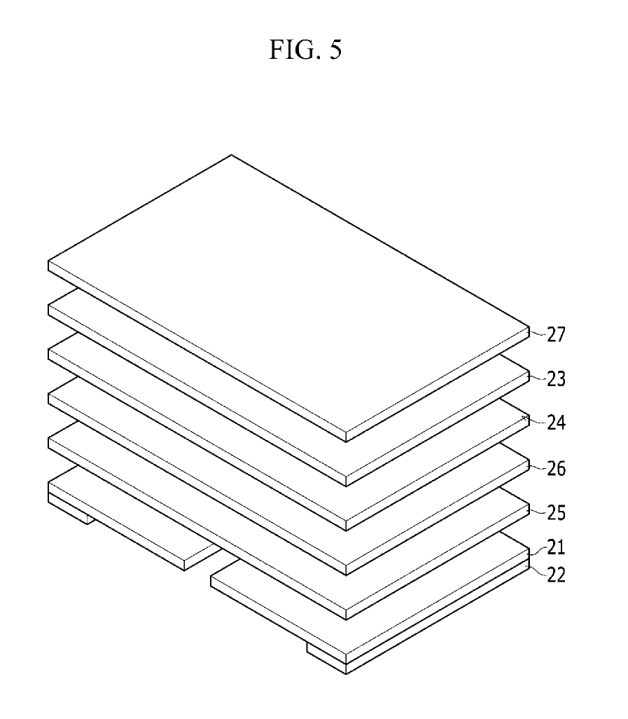

Hereinafter, another exemplary embodiment of the present invention will be described with reference to FIG. 5.

FIG. 5 is a perspective view illustrating one light source unit of the backlight unit according to another exemplary embodiment of the present invention.

FIG. 5 is a diagram corresponding to FIG. 3. Unlike the exemplary embodiment of FIG. 3, FIG. 5 illustrates a structure in which the lower electrodes 21 are separated from each other in the two adjacent light source units.

That is, as illustrated in FIG. 5, the two adjacent light source units have the lower electrodes 21 which are separated from each other, and thus are connected to different auxiliary electrodes 22. Therefore, the two adjacent light source units may be switched on and off at different timings.

The exemplary embodiment of FIG. 5 illustrates the two light source units adjacent to each other in a horizontal direction in the structure of FIG. 2 and also illustrates two light source units adjacent to each other in a vertical direction in other structures.

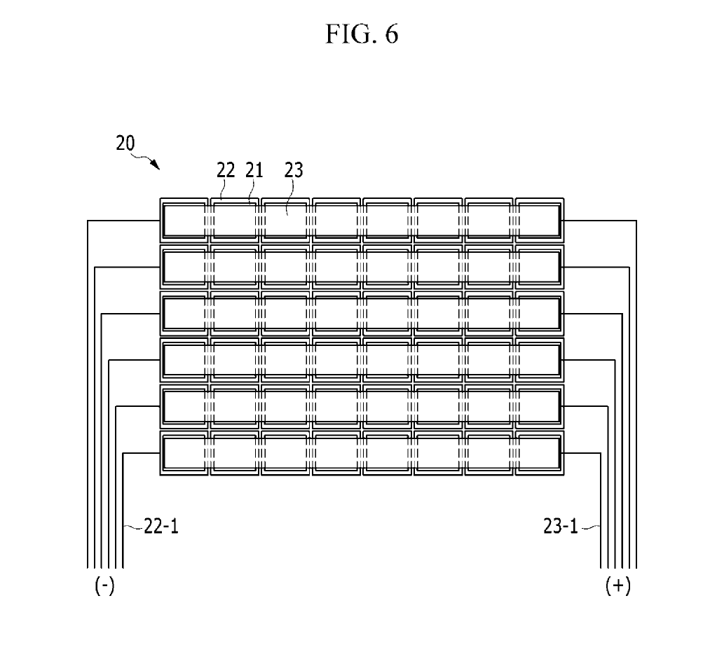

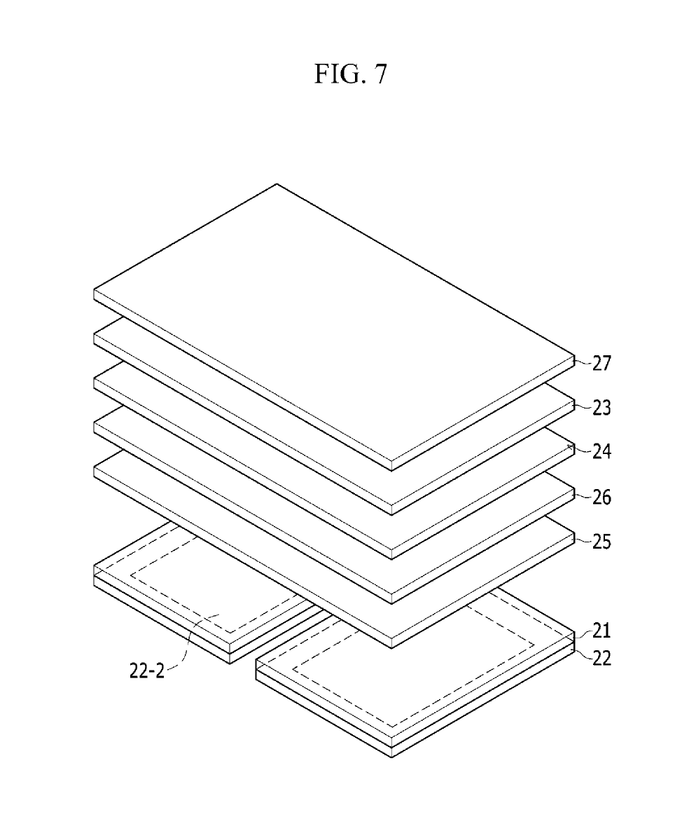

Hereinafter, the backlight unit according to another exemplary embodiment of the present invention will be described with reference to FIGS. 6 and 7.

FIG. 6 is a layout view of a backlight unit according to another exemplary embodiment of the present invention and FIG. 7 is a perspective view illustrating two light source units of the backlight unit according to another exemplary embodiment of the present invention.

The exemplary embodiment of FIGS. 6 and 7 has a structure in which the upper electrodes 23 extend in a horizontal direction and the lower electrodes 21 are connected to each other in a vertical direction while being separately formed for each light source unit. According to the above structure, light is emitted from the inorganic emission layer 26 of the selected light source unit when a positive voltage applied to the upper electrode 23 and a negative voltage applied to the lower electrode 21 are applied together. A method of selecting the light source unit by the above method may be referred to as a non-emissive method.

The structure of the backlight unit 20 according to the exemplary embodiment of the present invention will be described in detail with reference to FIGS. 6 and 7.

The upper electrode 23 is disposed beneath the upper substrate 27 which may be made of a various materials, such as glass or flexible plastic, such as polyethylene terephthalate (PET). The upper electrode 23 may be made of a transparent conductive material such as ITO and IZO and is provided with a plurality of linear electrodes formed in parallel, which extends in a first direction (horizontal direction in the exemplary embodiment). The upper electrode 23 is configured to be an anode, in which light is emitted through the upper electrode 23. The upper electrodes 23 are each connected to first wirings 23-1 which apply a voltage to the upper electrodes 23. The upper electrodes 23 are each connected to the first wirings 23-1, such that each of the upper electrodes 23 may be applied with different voltages.

The inorganic emission layer 26 is disposed under the upper electrode 23 and the upper insulating layer 24 is disposed between the inorganic emission layer 26 and the upper electrode 23. The upper insulating layer 24 may be made of an inorganic insulating material or an organic insulating material and may be configured to protect the inorganic emission layer 26. The upper insulating layer 24 may be omitted according to the exemplary embodiment of the present invention.

The inorganic emission layer 26 is disposed beneath the upper insulating layer 24.

The inorganic emission layer 26 is made of an inorganic material and has fluorescent characteristics when light is emitted by an applied current. The inorganic material used in the inorganic emission layer 26 may vary and, thus, a wavelength of light emitted may be different depending on the inorganic material used. For example, an inorganic emission layer 26 emitting light having a blue wavelength may also change a wavelength of light which is emitted by using an additional fluorescent material. Further, various combinations may be implemented, depending on the developed inorganic fluorescent material. This will be described with reference to FIGS. 12 and 13.

The lower insulating layer 25 is disposed beneath the inorganic emission layer 26. The lower insulating layer 25 may be made of an inorganic insulating material or an organic insulating material and may be configured to protect the inorganic emission layer 26. The lower insulating layer 25 may be omitted. At least one of the lower insulating layer 25 and the upper insulating layer 24 may be included and the materials configuring the upper insulating layer 24 and the lower insulating layer 25 may be the same.

The lower electrode 21 is disposed beneath the lower insulating layer 25. The lower electrode 21 may be made of an opaque metal such as magnesium (Mg), aluminum (Al), or silver (Ag), and are separately formed for each light source unit. However, the plurality of lower electrodes 21 arranged in a vertical direction among the lower electrodes 21 are separately formed and arranged in a matrix are connected to each other. That is, the lower electrodes 21 are not directly connected to each other but the auxiliary electrodes 22 disposed beneath the lower electrodes 21 are connected to each other such that the lower electrodes 21 are electrically connected to each other in a vertical direction. The lower electrode 21 is configured to be a cathode and reflects light such that light is not emitted beyond the lower electrode 21.

The auxiliary electrode 22 is formed beneath the lower electrode 21 under an area occupied by the lower electrode 21. The auxiliary electrode 22 forms a closed curved line along the outside of the lower electrode 21 and a center thereof is provided with an opening 22-2. That is, the auxiliary electrode 22 overlaps the lower electrode 21, except for the opening 22-2. Hereinafter, this is also referred to as a quadrangular ring structure. A portion of the lower electrodes 21 according to the exemplary embodiment may protrude outside the auxiliary electrode 22, or a portion of the auxiliary electrodes 22 may protrude outside the lower electrode 21.

The auxiliary electrode 22 directly contacts the lower electrode 21 to transfer a signal applied to the auxiliary electrode 22 to the lower electrode 21. The auxiliary electrodes 22 are arranged in a vertical direction and are electrically connected to each other. As a result, the lower electrodes 21 are electrically connected to each other in a vertical direction. The auxiliary electrode 22 may be made of a metal that improves signal transfer characteristics of the lower electrode 21, such as copper (Cu).

The auxiliary electrodes 22 are each connected to the second wirings 22-1 which apply a voltage to the lower electrode 21 from the outside. The auxiliary electrodes 22 are each connected to the second wirings 22-1, such that each of the auxiliary electrodes 22 may be applied with different voltages.

FIG. 7 is a perspective view illustrating two light source units disposed adjacent to each other in a horizontal direction.

As illustrated in FIG. 7, the two light source units disposed adjacent to each other in a horizontal direction have the lower electrodes 21 which are separated from each other, such that the two light source units may be switched on and off at different timings.

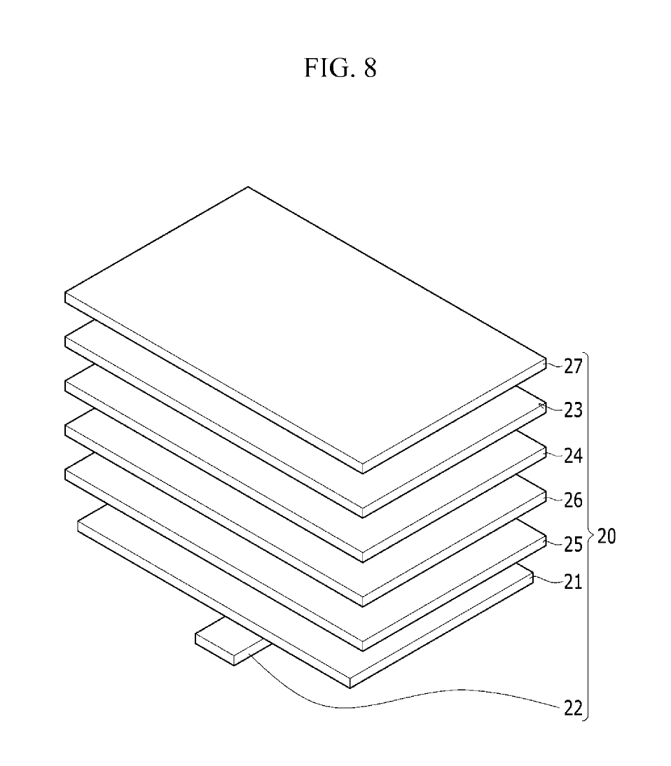

Hereinafter, another exemplary embodiment of the present invention will be described with reference to FIG. 8.

FIG. 8 is a perspective view illustrating one light source unit of the backlight unit according to another exemplary embodiment of the present invention.

Unlike the exemplary embodiments of FIGS. 3 and 5, the exemplary embodiment of FIG. 8 illustrates a structure in which the auxiliary electrode 22 passes through the center of one light source unit. That is, FIGS. 3 and 5 illustrate a structure in which the auxiliary electrodes 22 are disposed along an outer border of one light source unit, but FIG. 8 illustrates a structure in which the auxiliary electrodes 22 pass through the center of the light source unit. The auxiliary electrodes 22 may be disposed at various positions.

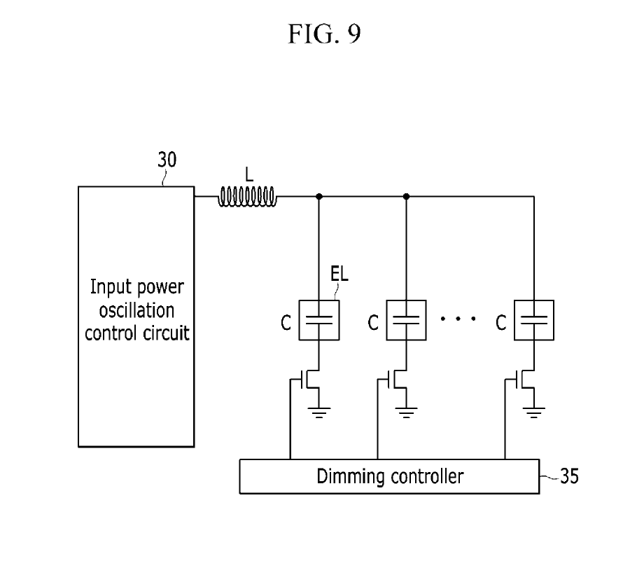

The non-emissive backlight unit illustrated in FIGS. 2, 4, and 6 may be driven with reference to a circuit structure illustrated in FIG. 9.

FIG. 9 is a circuit diagram of a backlight unit according to another exemplary embodiment of the present invention.

As illustrated in FIG. 9, each light source unit C has a pair of electrodes which include an inorganic emission layer EL. FIG. 9 fully illustrates only one light source unit C. Further, the light source unit C illustrated in FIG. 9 may be one in which the plurality of light source units illustrated in FIGS. 2 to 8 are included. That is, the plurality of light source units, to which one electrode is connected, are illustrated as one.

The pair of electrodes of the light source unit C are each applied with a high voltage and a low voltage to make a current flow in the inorganic emission layer EL. Here, a ground voltage is illustrated as a low voltage and a voltage provided from an input power oscillation control circuit 30 is illustrated as a high voltage.

The input power oscillation control circuit 30 generates and provides a voltage which allows the light source unit C to emit light.

The voltage generated from the input power oscillation control circuit 30 is transferred to each of the light source units C via a coil L. The coil L is an arbitrarily illustrated electronic device, which may be a device which is not present and schematically illustrates an LC delay provided at the time of transmitting a voltage.

A voltage from the input power oscillation control circuit 30 may be continuously applied to an electrode of one side of each of the light source units C. However, the light source unit C emits light only when a voltage is applied to an electrode of the other side of each of the light source units C.

Since local dimming driving capable of selectively switching on and off each of the light source units C may be included in the backlight unit according to the exemplary embodiment, such as that illustrated in FIG. 9, a transistor serving as a switch may be formed at the electrode of the other side of each of the light source units C. The transistor of FIG. 9 may connect or disconnect the electrode of the other side of the light source unit C to or from a ground terminal and a control signal used for this purpose may be transferred from a dimming controller 35 to a control terminal of the transistor. When a voltage turning on the transistor is applied from the dimming controller 35, the electrode of the other side of the light source unit C is connected to the ground terminal to make a current flow in the inorganic emission layer EL, thereby emitting light. The dimming controller 35 controls a switch on and off of each of the light source units C depending on display characteristics of the display panel 300, thereby improving the display quality.

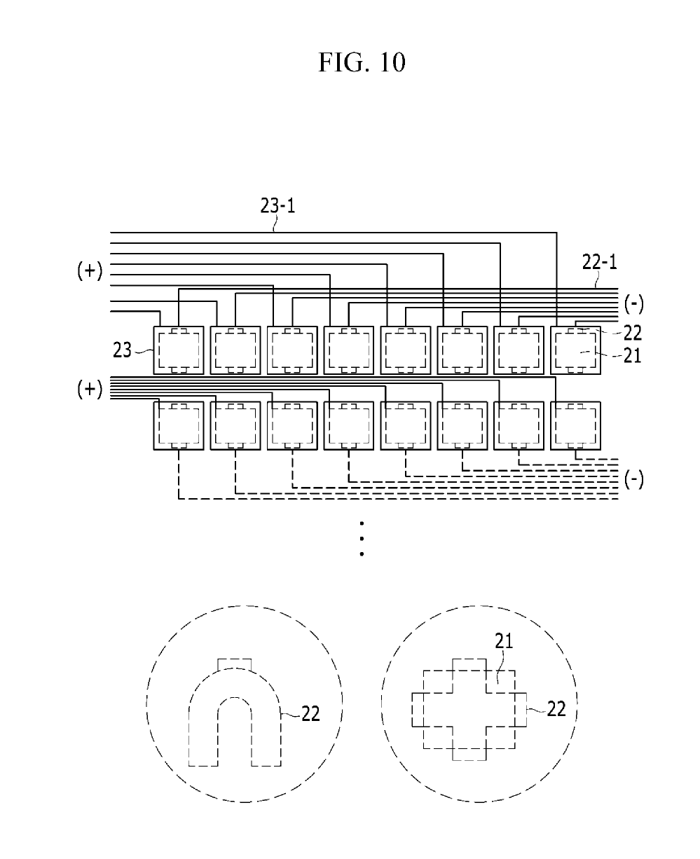

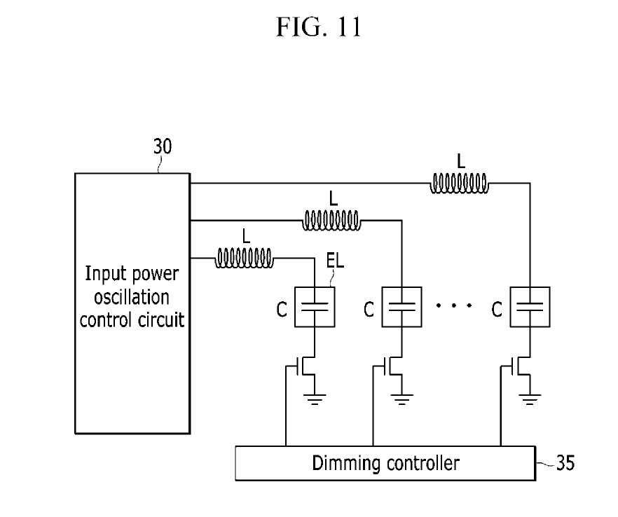

Hereinafter, an active type backlight unit will be described with reference to FIGS. 10 and 11.

First, the structure of the backlight unit will be described with reference to FIG. 10.

FIG. 10 is a layout view of a portion of a backlight unit according to another exemplary embodiment of the present invention.

The exemplary embodiment of FIG. 10 has a structure in which both of the upper electrode 23 and the lower electrode 21 are individually formed to have a size corresponding to the one light source unit. The individually-formed upper electrode 23 and lower electrode 21 are arranged in a matrix and the plurality of light source units are also arranged in a matrix. Further, each of the upper electrode 23 and the lower electrode 21 is formed so that different signals may be applied to the upper electrode 23 and the lower electrode 21. The upper electrode 23 and the lower electrode 21 may be adjacent to each other. That is, the adjacent upper electrodes 23 may be connected to each other by different first wirings 23-1. Each of the lower electrodes 21 may be connected to each of the auxiliary electrodes 22 and the auxiliary electrodes 22 may also be connected by different second wirings 22-1.

As such, a structure in which different signals may be applied to all the adjacent electrodes may be referred to as an active structure.

The structure of the backlight unit 20 according to the exemplary embodiment of FIG. 10 may be as follows.

The upper electrode 23 is disposed beneath the upper substrate, which may be made of glass or a flexible plastic such as polyethylene terephthalate (PET). The upper electrode 23 may be made of a transparent conductive material, such as ITO and IZO, and may be formed to have a structure to be separated for each light source unit. The upper electrode 23 is configured to be an anode, which emits light through the upper electrode 23. The upper electrodes 23 are each connected to first wirings 23-1 which apply a voltage to the upper electrodes 23. The upper electrodes 23 are each connected to the first wirings 23-1, such that each of the upper electrodes 23 may be applied with different voltages.

The inorganic emission layer may be disposed under the upper electrode 23 and the upper insulating layer may be disposed between the inorganic emission layer and the upper electrode 23. The upper insulating layer may be made of an inorganic insulating material or an organic insulating material and may be configured to protect the inorganic emission layer.

The inorganic emission layer may be disposed beneath the upper insulating layer. The inorganic emission layer is made of an inorganic material that has fluorescent characteristics when light is emitted by an applied current. The inorganic material used in the inorganic emission layer may include various materials, thus, a wavelength of light emitted may be different based on the material used. For example, the inorganic emission layer emitting light having a blue wavelength may also change a wavelength of light which is emitted using an additional fluorescent material.

The lower insulating layer may be disposed beneath the inorganic emission layer. The lower insulating layer may be made of an inorganic insulating material or an organic insulating material and may be configured to protect the inorganic emission layer.

At least one of the lower insulating layer and the upper insulating layer may be included and the materials comprising the upper insulating layer and the lower insulating layer may also be the same as each other.

The lower electrode 21 is disposed beneath the lower insulating layer. The lower electrode 21 may be made of an opaque metal, such as magnesium (Mg), aluminum (Al), or silver (Ag), and may be formed separately for each light source unit. The lower electrode 21 may be configured as a cathode and reflects light, such that light is not emitted beyond the lower electrode 21.

The auxiliary electrode 22 is formed beneath the lower electrode 21 under the area occupied by the lower electrode 21. The auxiliary electrode 22 is formed beneath the lower electrode 21 and crosses a central portion of the lower electrode 21. The auxiliary electrode 22 directly contacts the lower electrode 21 to directly transfer a signal applied to the auxiliary electrode 22 to the lower electrode 21. The auxiliary electrode 22 may be made of a metal that improves signal transfer characteristics of the lower electrode 21, such as copper (Cu).

The auxiliary electrodes 22 are each connected to the second wirings 22-1 which apply a voltage to the lower electrode 21. The auxiliary electrodes 22 are each connected to the second wirings 22-1, such that each of the auxiliary electrodes 22 may be applied with different voltages.

The structure of the auxiliary electrode 22 which is disposed beneath the lower electrode 21 may vary. FIG. 10 illustrates exemplary embodiments where the auxiliary electrode 22 has other shapes, such as a cruciform shape or a horseshoe shape. Further, the auxiliary electrode 22 may also have a quadrangular ring structure as illustrated in FIG. 7.

The active type backlight units 20 may be separately driven since all the electrodes of each of the light source units are separated from each other. An exemplary embodiment for driving this will be described with reference to FIG. 11.

FIG. 11 is a circuit diagram illustrating the backlight unit according to another exemplary embodiment of the present invention.

As illustrated in FIG. 11, each light source unit C has a pair of electrodes which include an inorganic emission layer EL. Unlike FIG. 9, each of the light source units C illustrated in FIG. 11 actually correspond to one light source unit C. That is, in the active type, it is possible to control each of the light source units C.

The pair of electrodes of the light source unit C are each applied with a high voltage and a low voltage to make a current flow in the inorganic emission layer EL. Here, a ground voltage is illustrated as a low voltage and a voltage provided from an input power oscillation control circuit 30 is illustrated as a high voltage.

The input power oscillation control circuit 30 generates and provides a voltage which allows the light source unit C to emit light.

The voltage generated from the input power oscillation control circuit 30 is transferred to each of the light source units C via each coil L. The coil L is an arbitrarily illustrated electronic device, which may be a device which is not present and schematically illustrates an LC delay provided at the time of transmitting a voltage.

In the input power oscillation control circuit 30, a voltage is applied or is not applied to the electrodes of one side of each of the light source units C. Even though a voltage is applied to the electrode of one side of the light source unit C, the light source unit C emits light only when a voltage is applied to the electrode of the other side of the light source unit C.

In the backlight unit according to the exemplary embodiment described above, the local dimming driving capable of switching on and off each of the light source units C may be performed.

That is, the input power oscillation control circuit 30 applies a voltage and the transistors serving as a switch, which are formed at the electrodes of the other side of each of the light source units C. When the switch is turned on the corresponding light source unit C emits light when the ground voltage is applied to the electrodes of the other side of the light source unit C.

To this end, the input power oscillation control circuit 30 is controlled, and the dimming controller 35 is also controlled. That is, when the voltage turning on the transistor is applied from the dimming controller 35, the electrode of the other side of the light source unit C is connected to the ground terminal and when a voltage turning off the transistor is applied, the electrode of the other side thereof floats, such that the light source unit C does not emit light even though a voltage is applied to the electrode of one side thereof.

The local dimming is performed by controlling the timing. Local dimming may vary depending on a screen displayed on the display panel 300 and characteristics of the display panel 300.

Hereinafter, the light source unit representing different colors will be described with reference to FIGS. 12 and 13.

FIGS. 12 and 13 are perspective views illustrating a configuration of the light source unit having different display colors according to the exemplary embodiment of the present invention.

The entire structure of the light source unit illustrated in FIGS. 12 and 13 is the same as the structure described above, but has a difference in only the inorganic emission layer 26.

In FIG. 12, the inorganic emission layer 26 is shown having a red inorganic emission layer 26-R, a green inorganic emission layer 26-G, and a blue inorganic emission layer 26-B. Thus the light source unit is divided into a red light source unit, a green light source unit, and a blue light source unit. Generally, since the light provided from the backlight may have a white color, the red light source unit, the green light source unit, and the blue light source unit are integrated so as to be switched on and off together, such that the white light may be locally dimmed.

FIG. 12 illustrates the case in which the materials of the inorganic emission layer 26 are different from each other in order to display red, blue, and green colors.

FIG. 13 illustrates an exemplary embodiment allowing the inorganic emission layer 26 to display colors by mixing a blue phosphor 26-B and a fluorescent pigment of a specific color.

One light emitting unit includes only the blue phosphor 26-B. One of the other two light emitting units includes the blue phosphor 26-B and a red fluorescent pigment 26-R′ and the other one includes the blue phosphor 26-B and a green fluorescent pigment 26-G′.

According to the exemplary embodiment of FIG. 13, three light emitting units are integrated so as to be switched on and off together, such that the local dimming may be performed.

In addition to the example of FIG. 13, the plurality of light emitting units may be formed in various combinations and may be integrated such that the local dimming may be performed.

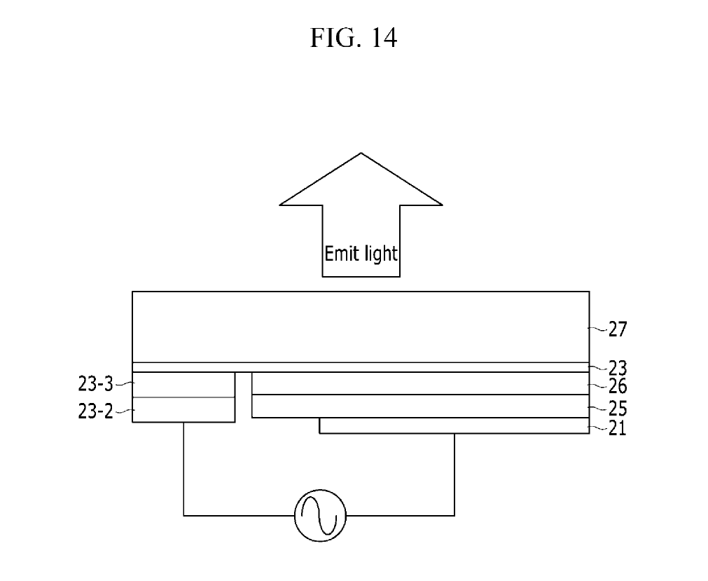

Hereinafter, a light source unit according to another exemplary embodiment of the present invention will be described with reference to FIG. 14.

FIG. 14 is a cross-sectional view of a light source unit according to another exemplary embodiment of the present invention.

FIG. 14 illustrates a structure in which a voltage is applied to the upper electrode 23 through a pad part 23-1 and 23-2 which are stacked from below so as to apply a voltage to the upper electrode 23.

Since the wiring through which signals are applied to each of the light source units is generally disposed on an opposite side of the upper substrate 27 in order to apply a voltage to the upper electrode 23, FIG. 14 illustrates an example of the pad part structure.

The pad part includes an adhesive layer 23-3 and a second auxiliary electrode 23-2. The adhesive layer 23-3 may include a conductive particle such as silver (Ag) and an adhesive component. The adhesive layer 23-3 serves to connect one terminal of the upper electrode 23 to a second auxiliary electrode 23-2. The second auxiliary electrode 23-2 may be made of metal, such as copper (Cu), and is connected to the wiring 23-1 to be directly applied with a voltage. The applied voltage is transferred to the upper electrode 23 via the adhesive layer 23-3.

The second auxiliary electrode 23-2 is made of copper to facilitate the supply of charges and has a structure in which an adhesive layer 23-3, which may include silver (Ag), may be disposed between the upper electrode 23 and the second auxiliary electrode 23-2. This configuration may improve contact characteristics with the upper electrode 23 made of the transparent conductive material, such as ITO.

In FIG. 14, the auxiliary electrode 22 beneath the lower electrode 21 is omitted, since the auxiliary electrode 22 is not necessarily required, but may be present. If present, the auxiliary electrode 22 may be formed beneath the lower electrode 21.

The structures of the light source units according to various exemplary embodiments have been described above.

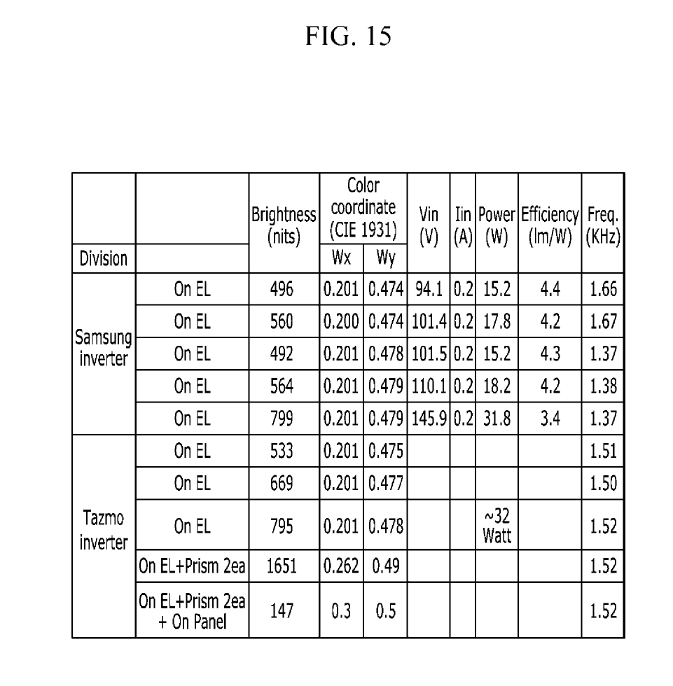

Hereinafter, the characteristics of the light source unit according to the exemplary embodiment of the present invention will be described with reference to FIG. 15.

FIG. 15 is a table illustrating characteristics of the backlight unit according to the exemplary embodiment of the present invention.

FIG. 15 illustrates a color coordinate, power consumption, and efficiency according to the exemplary embodiment of the present invention in case of using two kinds of different inverters (Samsung inverter and Tazmo inverter). In FIG. 15, the color coordinate, the power consumption, and the efficiency are measured in the state in which the local dimming driving is not performed and all the light source units are turned on.

Since the light source unit according to the exemplary embodiment of the present invention uses an inorganic light emitting device, the light source unit has efficiency lower than that of the case using the existing light emitting diode (LED). Therefore, power consumption is an issue.

The power consumption illustrated in FIG. 15 has a value similar to or slightly higher than that of the light emitting diode (LED) which is Comparative Example. There is a difference therebetween depending on the driving type at the time of performing the local driving, but an overall reduction of power consumption of 30 to 40% may be realized. As a result, the backlight unit including the inorganic emission layer which may perform the local driving as in the exemplary embodiment of the present invention has an advantage in power consumption in that it consumes less power.

Further, in final two rows of FIG. 15, only the inorganic light emitting device is not used, but instead, two sheets of prisms (2ea) are additionally disposed on a front surface of the backlight. Further, in the final row among them, in addition to two sheets of prisms, the display panel 300 is disposed and then the luminance is measured at the front surface of the display panel. In this case, the two sheets of prism sheets are arranged to make the directions of the prisms different. As can be appreciated, when two sheets of prisms are added, the luminance at the front surface of the display panel is improved two or more times than that of the case when prisims are not added. Therefore, an optical sheet, such as the prism sheet, may be included in the backlight unit.

Further, when the display panel is used, the luminance at the front surface of the display panel is reduced to 1/10, which is inevitably a drawback of the non-emissive display device. Therefore, it is difficult to improve the reduction of luminance. However, by using the backlight unit 20 according to the exemplary embodiment of the present invention, the power consumption is reduced, such that the same display luminance of the display device may be provided at smaller power consumption. As a result, it can be appreciated that the backlight unit including the inorganic emission layer may be driven with smaller power consumption.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A backlight unit, comprising:
an upper substrate; and
light source units disposed under the upper substrate, each light source unit comprising an upper electrode, a lower electrode, and an inorganic emission layer disposed between the upper electrode and the lower electrode,
wherein at least one of the upper electrodes and the lower electrodes in adjacent light source units are electrically separated from each other.

2. The backlight unit of claim 1, wherein:
the adjacent light source units are adjacent to each other in a vertical direction; and
the upper electrodes are separated from each other, the lower electrodes integrally formed with each other, and the inorganic emission layers are integrally formed with each other.

3. The backlight unit of claim 1, wherein:
in the adjacent light source units, the upper electrodes are connected to each other, the lower electrodes are separated from each other, and the organic emission layers are connected to each other.

4. The backlight unit of claim 1, wherein the light source units further comprise:
an insulating layer disposed between the inorganic emission layer and the upper electrode or between the inorganic emission layer and the lower electrode, and an auxiliary pad contacting a lower portion of the lower electrode.

5. The backlight unit of claim 4, wherein:
the auxiliary electrode has one of a linear shape, a quadrangular ring shape, and a horseshoe shape.

6. The backlight unit of claim 1, further comprising:
an input power oscillation control circuit configured to provide a voltage to one of the upper electrode and the lower electrode of the light source unit;
a transistor connected to the other one of the upper electrode and the lower electrode of the light source unit; and
a dimming controller configured to provide a control signal to a control terminal of the transistor.

7. The backlight unit of claim 6, wherein:
the input power oscillation control circuit is connected to one of the upper electrode and the lower electrode of the light source unit by a separate wiring, and the dimming controller is connected to control terminals of the transistor, respectively, by the separate wiring.

8. The backlight unit of claim 1, further comprising a pad part, wherein:
the upper electrode is configured to receive a voltage through the pad part, and the pad part comprises an adhesive layer and a second auxiliary electrode.

9. The backlight unit of claim 1, wherein:
the light source unit comprises at least three light source units having different colors, the inorganic emission layer of one of the light source units comprising a red inorganic emission layer, the inorganic emission layer of another light source unit comprising a green inorganic emission layer, and the inorganic emission layer comprised in the remaining one comprising a blue inorganic emission layer.

10. The backlight unit of claim 9, wherein:
the at least three light source units are configured so as to be switched on and off together.

11. The backlight unit of claim 1, wherein:
the light source unit comprises at least three light source units having different colors, the inorganic emission layer of one of the light source units comprising only a blue phosphor, the inorganic emission layer of another light source unit comprising a blue phosphor and a red fluorescent pigment, and the inorganic emission layer of the remaining one comprising the blue phosphor and a green fluorescent pigment.

12. The backlight unit of claim 11, wherein:
the at least three light source units are integrated so as to be switched on and off together.

13. The backlight unit of claim 1, wherein:
in the adjacent light source units, the upper electrode and the lower electrode are separated from each other and the inorganic emission layers are connected to each other.

14. The backlight unit of claim 13, further comprising:
an input power oscillation control circuit configured to provide a voltage to one of the upper electrode and the lower electrode of the light source unit;
a transistor connected to the other one of the upper electrode and the lower electrode of the light source unit; and
a dimming controller configured to provide a control signal to a control terminal of the transistor.

15. The backlight unit of claim 14, wherein:
the input power oscillation control circuit is connected to one of the upper electrode and the lower electrode of the light source unit by a separate wiring, and the dimming controller is connected to control terminals of the transistor, by the separate wiring.

16. A display device, comprising:
a non-emissive display panel; and
a backlight unit configured to provide light to the non-emissive display panel, the backlight unit comprising an upper substrate and light source units disposed under the upper substrate, the light source units each comprising an upper electrode, a lower electrode, and an inorganic emission layer disposed between the upper electrode and the lower electrode,
wherein at least one of the upper electrodes and the lower electrodes in adjacent light source units are electrically separated from each other.

17. The display device of claim 16, further comprising:
an optical sheet disposed between the non-emissive display panel and the backlight unit.

18. The display device of claim 17, wherein:
the optical sheet comprises two sheets of prism sheets.

19. The display device of claim 17, wherein:
the optical sheet comprises a diffuser sheet and a luminance enhancement film in which two layers having different refractive indexes are alternately disposed.
